(19) United States
(12) Patent Application Publication
(10) Pub. No.: US 2004/0140193 A1
(43) Pub. Date: Jul. 22, 2004

(54) Tact switch with secured seal pad

(76) Inventors: Yan Min Liu, Kunsan (CN); Ren-Chih Li, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/652,438

(22) Filed: Aug. 28, 2003

(30) Foreign Application Priority Data
Jan. 22, 2003 (TW) 92201183

(51) Int. Cl. H01H 5/18

(52) U.S. Cl. 200/406

(57) ABSTRACT

A tact switch (1) includes a housing (10) defining a cavity (1000) in a middle thereof, a first contact (11) and a second contact (12) received in a portion of the housing under the cavity, a dome-shaped metal spring (13) mounted in the cavity, a seal pad (14) mounted on a top of the housing, a metal shell (15) covering the housing, and a push button (16) engaging with the shell and attached on the seal pad. The shell comprises a base portion (153), and three sidewalls (151) and a tab (152) respectively perpendicularly depending from edges of the base portion. The seal pad is substantially rectangular, and frictionally fitted between two opposite of the sidewalls and the tab at an underside of the base portion. Therefore, the seal pad is securely retained in a correct position in the shell in assembling.

### BACKGROUND OF THE INVENTION

1. Field of the Invention

The present invention relates to a tact switch used in an electronic device such as a server, the tact switch having a momentary push button for establishing an electrical connection between desired terminals in the electronic device.

2. Description of the prior art

At present, tact switches are widely used in electronic devices such as servers. The tact switch enables an electrical connection between two desired terminals in the electronic device. Such switch is described in the article “Development of a Switch Connector” obtained from the web journal “Connector Specifier” (April, 2001). A similar switch is also disclosed in U.S. Pat. No. 4,803,321.

Referring to FIGS. 5 and 6, a conventional tact switch 6 comprises an insulative housing 60, a first contact 61 and a second contact 66 embedded in the housing 60, a dome-shaped metal spring 62 mounted in the housing 60, a circular seal pad 64 mounted on a top of the housing 60, a metal shell 63 covering the housing 60, and a push button 65 engaging with the shell 63 and attached on the seal pad 64.

The housing 60 defines a cavity 600 in a middle thereof, and forms a pair of wedges 601 outwardly from two opposite sidewalls thereof. Portions of the first contact 61 and the second contact 66 are embedded in a portion of the housing 60 under the cavity 600. The first contact 61 has two opposite contact portions 610 exposed in the cavity 600, and a solder portion 611 protruding out from the housing 60 for electrically connecting with a terminal (not shown) of an electronic device. The second contact 66 has a contact portion 660 exposed in the cavity 600 between the contact portions 610 of the first contact 61, and a solder portion 661 protruding out from the housing 60 for electrically connecting with another terminal (not shown) of the electronic device. The shell 63 comprises a base portion 631, and three sidewalls 630 perpendicularly depending from three edges of the base portion 631 respectively. The base portion 631 defines an opening 6310 in a middle thereof. A pair of windows 6300 is defined in two opposite of the sidewalls 630, for engagingly receiving the wedges 601 of the housing 60. The seal pad 64 comprises a recessed portion 640, and a protrusion 641 formed on a middle of an underside of the recessed portion 640. The push button 65 comprises an acting member 651, and a cap 652 covering the acting member 651. The acting member 651 has a discoid pressing portion 6510 on a bottom end thereof. A diameter of the pressing portion 6510 is greater than that of a remainder of the acting member 651.

In assembly, the spring 62 is mounted in the cavity 600, with two opposite peripheral portions of the spring 62 respectively resting on the corresponding contact portions 610 of the first contact 61, and a peak portion of the spring 62 disposed directly over the contact portion 660 of the second contact 66. The seal pad 64 is mounted on a top of the housing 60, with the protrusion 641 loosely contacting the peak portion of the spring 62. The acting member 651 of the push button 65 is passed through the opening 6310 from a bottom side of the base portion 631 of the shell 63. The shell 63 having the acting member 651 is engaged on the housing 60. The pressing portion 6510 is received in the recessed portion 640 of the seal pad 64, and the wedges 601 of the housing 60 engage with the shell 63 in the corresponding windows 6300. Therefore, the seal pad 64 is secured between the base portion 631 of the shell 63 and the top of the housing 60. Then, the cap 652 is engaged on the acting member 651.

In use, the solder portion 611 of the first contact 61 and the solder portion 661 of the second contact 66 are respectively electrically connected with said terminals of the electronic device. The cap 652 is pushed down, thereby driving the acting member 651 down. The pressing portion 6510 forces the recessed portion 640 of the seal pad 64 to elastically deform downwardly. The protrusion 641 drives the peak portion of the spring 62 to elastically deform downwardly, such that the peak portion contacts the contact portion 660 of the second contact 66. The second contact 66 is thereby electrically connected with the first contact 61 via the spring 62. Thus, an electrical connection is established between said terminals by the tact switch 6.

However, when assembling the shell 63 onto the housing 60, the seal pad 64 is liable to be mislocated therebetween. When the seal pad 64 is located at an incorrect position, two problems may arise. First, the pressing portion 6510 of the acting member 651 is not received in the recessed portion 640 of the seal pad 64, and the wedges 601 of the housing 60 cannot engage in the windows 6300 of the shell 63. In this case, the assembly operation must be repeated, which is troublesome and time-consuming. Secondly, the pressing portion 6510 is received in the recessed portion 640 of the seal pad 64, but the protrusion 641 of the seal pad 64 does not even loosely contact the peak portion of the spring 62. The wedges 601 engage in the windows 6300 of the shell 63. When the cap 652 is pushed down, the pressing portion 6510 forces the recessed portion 640 downwardly. The protrusion 641 drives a portion not being the peak portion of the spring 62 downwardly. The peak portion cannot contact the contact portion 660 of the second contact 66. Thus, an electrical connection between said terminals is not established. The tact switch 6 is inoperational or at the very least unreliable.

In view of the above, a new tact switch that overcomes the above-mentioned disadvantages is desired.

### SUMMARY OF THE INVENTION

Accordingly, an object of the present invention is to provide a tact switch for electrical connection between desired terminals, the tact switch being readily assembled and reliable.

To achieve the above-mentioned object, a tact switch in accordance with a preferred embodiment of the present invention comprises an insulative housing defining a cavity in a middle thereof, a first contact and a second contact embedded in a portion of housing under the cavity, a dome-shaped metal spring mounted in the cavity, a substantially rectangular seal pad mounted on the housing, a metal shell covering the housing, and a push button engaging with the shell and attached on the seal pad. Two opposite peripheral portions of the spring rest on the first contact, and a peak portion of the spring is disposed directly over the second contact. The seal pad defines a recess in a middle thereof and a protrusion formed on a middle of an underside thereof contacting the peak portion of the spring. The seal pad is frictionally fitted between two opposite of the sidewalls and the tab, at an underside of the base portion. Therefore, the seal pad is securely retained in a correct position in the shell in assembling. The push button is downwardly pressable to drive the protrusion of the seal pad down to force the spring to elastically deform downwardly to contact the second contact, thereby establishing an electrical connection between the first contact and the second contact.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a tact switch in accordance with the present invention;

FIG. 2 is an enlarged, isometric view of a seal pad of the tact switch of FIG. 1, but showing the seal pad inverted;

FIG. 3 is an enlarged, assembled view of FIG. 1;

FIG. 4 is a cross-sectional view taken along line IV-IV of FIG. 3;

FIG. 5 is an exploded, isometric view of a conventional tact switch; and

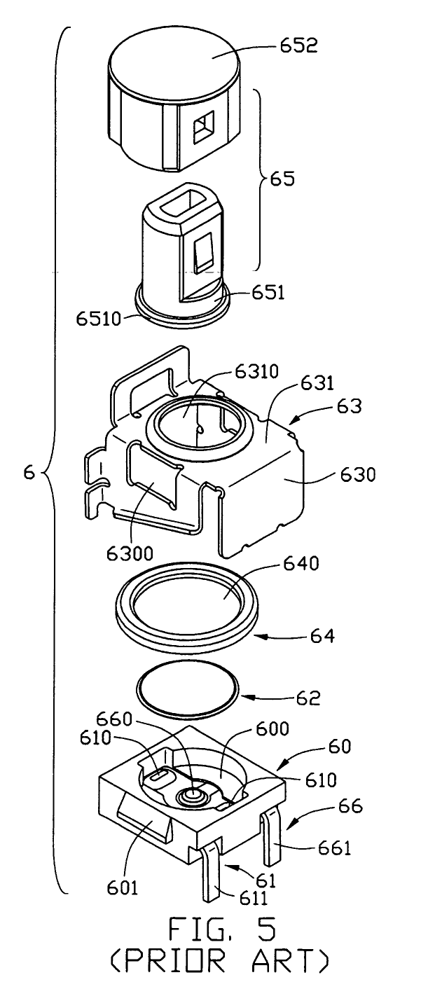

FIG. 6 is an enlarged, isometric view of a seal pad of the tact switch of FIG. 5, but showing the seal pad inverted.

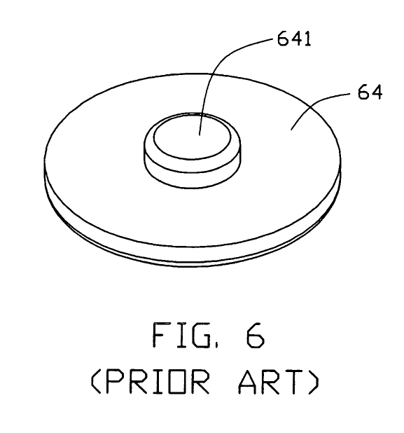

### DETAILED DESCRIPTION OF THE PREFERRED EMBODIMENT OF THE INVENTION

Reference will now be made to the drawings to describe the present invention in detail.

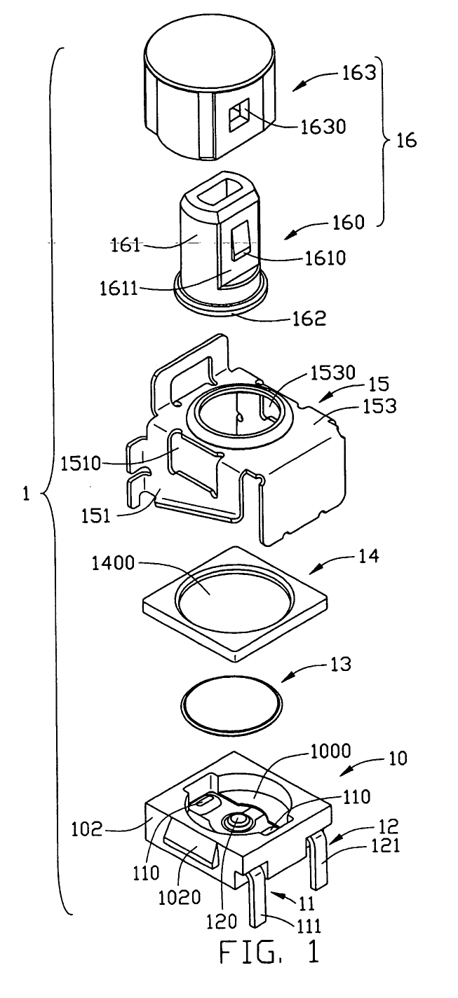

Referring to FIG. 1, a tact switch 1 in accordance with the preferred embodiment of the present invention is used in an electronic device such as a server (not shown). The tact switch 1 enables an electrical connection between two desired terminals (not shown) in the electronic device.

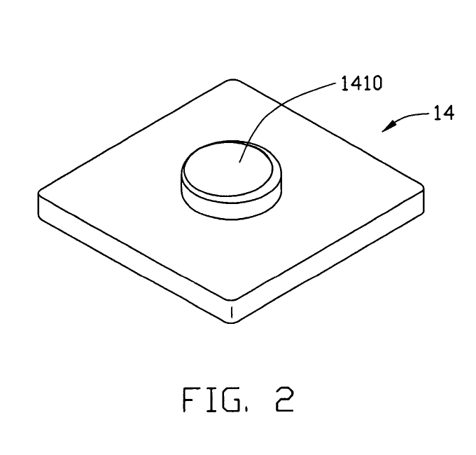

Also referring to FIG. 2, the tact switch 1 comprises an insulative housing 10, a first contact 11 and a second contact 12 embedded in the housing 10, a dome-shaped metal spring 13 mounted in the housing 10, a seal pad 14 mounted on a top of the housing 10, a metal shell 15 covering the housing 10, and a push button 16 engaging with the shell 15 and attached on the seal pad 14.

The housing 10 is substantially rectangular, and defines a cavity 1000 in a middle thereof. A pair of projecting portions 1020 is outwardly formed from two opposite sidewalls 102 of the housing 10. Each projecting portion 1020 is substantially wedge-shaped, and forms an engaging surface (not labeled) perpendicular to the respective sidewall 102.

Portions of the first contact 11 and the second contact 12 are embedded in a portion of the housing 10 under the cavity 1000. The first contact 11 has two opposite contact portions 110 exposed in the cavity 1000, and a solder portion 111 protruding out from the housing 10 for electrically connecting with one terminal of the electronic device. The second contact 12 has a contact portion 120 exposed in the cavity 1000 between the contact portions 110 of the first contact 11, and a solder portion 121 protruding out from the housing 10 for electrically connecting with another terminal of the electronic device.

Also referring to FIG. 2, the seal pad 14 is substantially rectangular, and defines a recess 1400 in a middle thereof. A protrusion 1410 is formed on a middle of an underside of the seal pad 14.

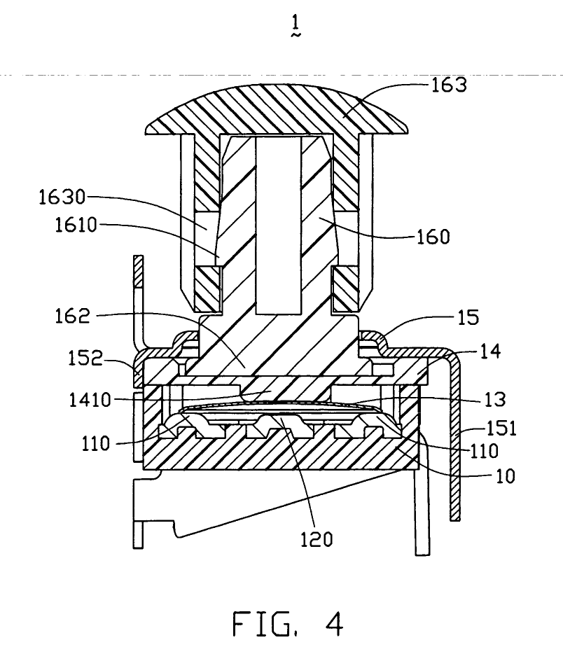

Also referring to FIG. 4, the shell 15 comprises a horizontal base portion 153, three sidewalls 151 perpendicularly depending from three edges of the base portion 153 respectively, and a tab 152 perpendicularly depending from a fourth edge of the base portion 153 opposite to one of the sidewalls 151. The base portion 153 defines an opening 1530 in a middle thereof. Two rectangular windows 1510 are defined in two opposite of the sidewalls 151 respectively.

The push button 16 comprises an acting member 160, and a cap 163 covering the acting member 160. The acting member 160 is substantially cylindrical, and comprises a body portion 161 and a discoid pressing portion 162 formed on a bottom end of the body portion 161. A diameter of the opening 1530 of the shell 15 is greater than a diameter of the body portion 161, but less than a diameter of the pressing portion 162. The body portion 161 forms two opposite planar surfaces 1611 on a circumferential periphery thereof. Each surface 1611 is parallel to a central longitudinal axis of the body portion 161, and outwardly forms a wedge 1610 from a middle thereof. The cap 163 defines two opposite generally rectangular holes 1630 in a circumferential periphery thereof, for engagingly receiving the wedges 1610.

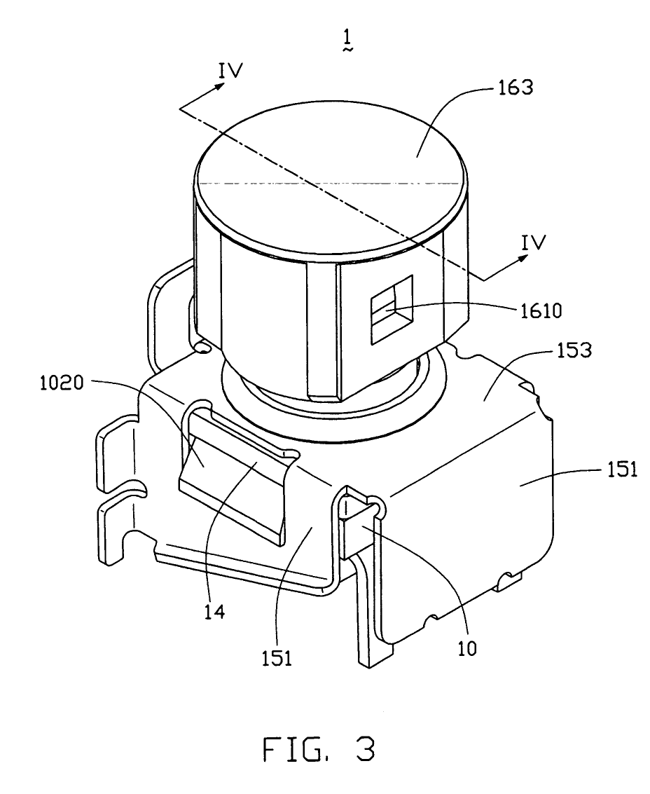

Referring to FIGS. 3 and 4, in assembly, the spring 13 is firstly mounted in the cavity 1000, with two opposite peripheral portions of the spring 13 respectively resting on the corresponding contact portions 110 of the first contact 11, and a peak portion of the spring 13 disposed directly over the contact portion 120 of the second contact 12. The acting member 160 of the push button 16 is passed through the opening 1530 of the shell 15 from a bottom side of the shell 15. The seal pad 14 is mounted in the shell 15 from the bottom side of the shell 15, with the pressing portion 162 of the acting member 160 being received in the recess 1400 of the seal pad 14. The seal pad 14 frictionally fits between said two opposite of the sidewalls 151 and the tab 152, at an underside of the base portion 153. The seal pad 14 is thus securely retained in a correct position in the shell 15. Then, the shell 15 having the acting member 160 and seal pad 14 is engaged on the housing 10. The projecting members 1020 firmly engage with the shell 15 in windows 1510. Hence, the seal pad 14 is firmly wedged between the base portion 153 and the top of the housing 10, with the protrusion 1410 of the seal pad 14 loosely contacting the peak portion of the spring 13. Finally, the cap 163 is engaged on the acting member 160, with the wedges 1610 engaging with the cap 163 in the holes 1630.

In use, the solder portion 111 of the first contact 11 and the solder portion 121 of the second contact 12 are respectively connected with said terminals of the electronic device. Then the cap 163 is pushed down, thereby driving the acting member 160 down. The pressing portion 162 forces the seal pad 14 to elastically deform downwardly. The protrusion 1410 drives the peak portion of the spring 13 to elastically deform downwardly, such that the peak portion of the spring 13 contacts the contact portion 120 of the second contact 12. The first contact 11 thereby electrically connects with the second contact 12 via the spring 13, such that said terminals are electrically connected with each other.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. A tact switch comprising:
an insulative housing defining a cavity in a middle thereof;
a first contact and a second contact received in the housing;
a dome-shaped metal spring mounted in the cavity of the housing and contacting the first contact;
a metal shell comprising a base portion and three sidewalls perpendicularly depending from three edges of the base portion respectively;
a substantially rectangular seal pad having a protrusion on a middle of an underside thereof, the seal pad being frictionally fitted between at least two sidewalls of the shell between the base portion and a top of the housing; and a push button engaging with the shell and attached on the seal pad, the push button being downwardly pressable to drive the protrusion of the seal pad down to force the spring to elastically deform downwardly to contact the second contact, then establishing an electrical connection between the first contact and the second contact.

2. The tact switch as claimed in claim 1, wherein the push button comprises an acting member and a cap engaged on the acting member.

3. The tact switch as claimed in claim 2, wherein the cap defines two opposite substantially rectangular holes in a circumferential periphery thereof, and the acting member outwardly forms two wedges engaging the cap in the corresponding holes.

4. The tact switch as claimed in claim 2, wherein the acting member has a discoid pressing portion on a bottom end thereof.

5. The tact switch as claimed in claim 4, wherein the seal pad defines a recess in a middle thereof for receiving the pressing portion.

6. The tact switch as claimed in claim 2, wherein the base portion of the shell defines an opening in a middle thereof, and the acting portion is passable through the opening from a bottom side of the base portion of the shell.

7. The tact switch as claimed in claim 1, the shell defines a pair of windows on two opposite of the sidewalls thereof, and the housing has two wedge-shaped projecting members outwardly formed from two opposite sidewalls thereof engaging the shell in the corresponding windows.

8. The tact switch as claimed in claim 1, wherein the shell has a tab perpendicularly depending from a fourth edge of the base portion, the tab frictionally fitting the seal pad cooperative with said at least two sidewalls of the shell.

9. A switch comprising:
an insulative housing defining a cavity therein;
first and second contacts disposed in the housing;
a downwardly deflectable piece located in the cavity with at least a portion thereof metallic material for electrically connecting said first and second contacts;
a shield enclosing said housing both vertically and horizontally;
a push button extending upwardly above a top plate of the shield and having on a bottom portion thereof a pressing portion below the top plate; and
a seal pad located right under said top plate and above said deflectable piece; wherein
said seal pad defines an exterior contour which is horizontally compliantly restrained by at least one of said housing and said shield.

10. The switch as claimed in claim 9, wherein said seal pad defines a protrusion on an underside thereof to engage the deflectable piece.

11. The switch as claimed in claim 9, wherein said seal pad defines a recess to receive said pressing portion therein.

12. The switch as claimed in claim 9, wherein said seal pad defines a rectangular exterior contour in compliance with a configuration of said shield for horizontal restraint.

13. The switch as claimed in claim 9, wherein said seal pad is sandwiched between top face of the housing and the top plate of the shield.

14. A switch comprising:
an insulative housing defining a cavity therein;
first and second contacts disposed in the housing;
a downwardly deflectable piece located in the cavity with at least a portion thereof metallic material for electrically connecting said first and second contacts;
a shield enclosing said housing both vertically and horizontally;
a push button extending upwardly above a top plate of the shield and having on a bottom portion thereof a pressing portion below the top plate; and
a seal pad located right under said top plate and above said deflectable piece; wherein
said seal pad is horizontally immoveable by means of horizontal abutment with said shield.

15. The switch as claimed in claim 14, wherein said seal pad defines a protrusion on an underside thereof to engage the deflectable piece.

16. The switch as claimed in claim 14, wherein said seal pad defines a recess to receive said pressing portion therein.

17. The switch as claimed in claim 14, wherein said seal pad defines a rectangular exterior contour in compliance with a configuration of said shield for horizontal restraint.

18. The switch as claimed in claim 14, wherein said seal pad is sandwiched between top face of the housing and the top plate of the shield.

19. The switch as claimed in claim 14, wherein a whole body of said deflectable piece is made of said metallic material.
